(19) United States
(12) Patent Application Publication
(10) Pub. No.: US 2026/0145188 A1
(43) Pub. Date: May 28, 2026

(54) SLOT-TYPE SPRAY NOZZLE

(71) Applicant: Toray Industries, Inc., Chuo-ku, Tokyo (JP)

(72) Inventors: Ryuta SAKASHITA, Otsu-shi, Shiga (JP); Kohei UEDA, Otsu-shi, Shiga (JP); Kiyoshi MINOURA, Otsu-shi, Shiga (JP)

(73) Assignee: Toray Industries, Inc., Chuo-ku, Tokyo (JP)

(21) Appl. No.: 19/120,603

(22) PCT Filed: Nov. 13, 2023
(86) PCT No.: PCT/JP2023/040692

§ 371 Date: Apr. 11, 2025

(30) Foreign Application Priority Data
Nov. 22, 2022 (JP) 2022-186208

(51) Int. Cl. B05B 7/02; B05B 7/08; B05C 5/02

(52) U.S. Cl. CPC B05B 7/025; B05B 7/0815; B05C 5/0254

(57) ABSTRACT

A slot-type spray nozzle includes at least two nozzle blocks, two air shim plates, two partition shim plates, and one coating fluid shim plate, which are layered in this order from an outside and an entirety of which are fastened in a layer direction by fixing bolts. A surface from which coating fluid is discharged is defined as a coating fluid discharge surface, and a direction perpendicular to a direction in which the coating fluid is discharged and the layer direction is defined as a width direction, a coating fluid manifold extending in the width direction and an air manifold extending in the width direction are provided, and in an end portion of the coating fluid shim plate on a side of the coating fluid discharge surface, grooves serving as a plurality of coating fluid discharge ports are formed at pitches.

### CROSS REFERENCE TO RELATED APPLICATIONS

This application is the U.S. National Phase of PCT/JP 2023/040692, filed Nov. 13, 2023, which claims priority to Japanese Patent Application No. 2022-186208, filed Nov. 22, 2022, the disclosures of these applications being incorporated herein by reference in their entities for all purposes.

### FIELD OF THE INVENTION

The present invention relates to a slot-type spray nozzle.

### BACKGROUND OF THE INVENTION

Conventionally, as a device for applying coating fluid to a substrate, a spray coating device is known in which coating fluid is formed into droplets by a spray nozzle (hereinafter, also simply referred to as a “nozzle”) and then sprayed. In a spray coating device, a one-fluid spray nozzle that forms coating fluid into droplets only by liquid pressure, or a two-fluid spray nozzle that discharges pressurized air simultaneously with the coating fluid, and atomizes and sprays the coating fluid by a driving force of the discharged air is generally used.

In this spray coating device, from the viewpoint of productivity and functionality of the substrate, it is often required to form a thin film with a uniform thickness on substantially the entire surface of the wide substrate. As a spray nozzle suitably used in such a case, for example, Patent Literature 1 discloses a slot-type spray nozzle having a plurality of coating fluid discharge ports in a coating width direction of a substrate and a pair of air discharge ports arranged so as to sandwich the coating fluid discharge ports opened continuously or intermittently in the width direction in the vicinity of the coating fluid discharge ports. In this spray nozzle, the coating fluid discharge port and the air discharge port are formed by combining four nozzle blocks and at least one shim plate, and fine coating fluid droplets can be generated by causing high-speed air to collide with the coating fluid discharged from the coating fluid discharge port. In addition, in the slot-type spray nozzle, a plurality of the coating fluid discharge ports can be arranged in the width direction at very narrow pitches of about 5 mm to 20 mm and thus thin film coating with high uniformity in the width direction can be performed.

Further, Patent Literature 2 discloses a nozzle for a liquid adhesive filament, in which a pair of nozzle blocks and a shim plate layer including five shim plates that are arranged between the nozzle blocks, and these are fastened with fixing bolts to constitute a nozzle. Since this shim plate layer type nozzle includes a coating fluid discharge port and an air discharge port having a structure similar to those of Patent Literature 1, the shim plate layer type nozzle can also be applied to spray, and is constituted by two nozzle blocks, and thus can be made smaller and lighter than the nozzle of Patent Literature 1 constituted by four nozzle blocks, and is excellent in handling property.

### Patent Literature

Patent Literature 1: JP 2006-026576 A

Patent Literature 2: JP 2008-212919 A

### SUMMARY OF THE INVENTION

In the case of embodying a spray nozzle capable of highly uniform thin film coating with the shim plate layer type nozzle structure disclosed in Patent Literature 2, it is necessary to form a minute flow path having an opening of several 10 μm to several 100 μm in order to realize uniform discharge control of a minute amount of coating fluid in the width direction and discharge of high-speed air, and a shim plate having an extremely thin thickness corresponding thereto is required.

However, since these thin shim plates have low rigidity, they are easily deformed by the nozzle internal pressure generated by the supplied coating fluid or pressurized air.

Therefore, it is difficult to maintain shapes of flow paths for ports such as the coating fluid discharge port and the air discharge port with high accuracy, and it becomes difficult to obtain high spray uniformity in the width direction.

In addition, in order to suppress the deformation of the shim plate, a method of suppressing the deformation of the shim plate by improving the tightness between the nozzle block and the shim by increasing the flatness of the surfaces of the two nozzle blocks in contact with the shim plate is conceivable.

However, in order to improve the flatness of the nozzle block, it is necessary to increase the rigidity of the nozzle block by enlarging the nozzle block, and it is difficult to achieve both the rigidity and the high handling property of the nozzle.

The present invention has been made in view of the above problems, and provides a small and lightweight slot-type spray nozzle capable of forming a uniform thin film on a wide substrate and having excellent handling property.

[1] The present invention to solve the problem above is a slot-type spray nozzle including at least two nozzle blocks, two air shim plates, two partition shim plates, and one coating fluid shim plate, which are layered in this order from an outside and an entirety of which are fastened in a layer direction by fixing bolts, wherein a surface from which coating fluid is discharged is defined as a coating fluid discharge surface, and a direction perpendicular to a direction in which the coating fluid is discharged and the layer direction is defined as a width direction, a coating fluid manifold extending in the width direction and an air manifold extending in the width direction are provided, in an end portion of the coating fluid shim plate on a side of the coating fluid discharge surface, grooves serving as a plurality of coating fluid discharge ports are formed at pitches, and the coating fluid manifold and the plurality of coating fluid discharge ports communicate with each other, in an end portion of each of the two air shim plates on the side of the coating fluid discharge surface, grooves serving as a plurality of air discharge ports are formed at a pitch, and the air manifold and the plurality of air discharge ports communicate with each other, the coating fluid discharge surface has a region where the coating fluid discharge ports and the air discharge ports do not exist in the layer direction, and the fixing bolt fastens the slot-type spray nozzle at a position closer to the coating fluid discharge surface than the coating fluid manifold and the air manifold.

The slot-type spray nozzle according to the present invention preferably has any of the following embodiments [2] to [8].

[2]. The slot-type spray nozzle according to [1] further including a second air manifold extending in the width direction at a position closer to the coating fluid discharge surface than a fastening position of the fixing bolt, wherein the air manifold and the plurality of air discharge ports communicate with each other via the second air manifold.

[3] The slot-type spray nozzle according to [2] in which a flow path that allows the coating fluid manifold and the plurality of coating fluid discharge ports to communicate with each other is disposed at a position not overlapping with a flow path that allows the air manifold and the second air manifold to communicate with each other as viewed from the layer direction.

[4] The slot-type spray nozzle according to any one of [1] to [3] in which a recess constituting the coating fluid manifold is formed only in one of the nozzle blocks, and a recess constituting the air manifold is formed only in another of the nozzle blocks, and the coating fluid manifold is disposed at a position overlapping with the air manifold as viewed from the layer direction.

[5] The slot-type spray nozzle according to any one of [2] to [4] in which a flow path that allows the air manifold and the second air manifold to communicate with each other includes a main flow path, a first sub flow path that allows the main flow path and the air manifold to communicate with each other, and a second sub flow path that allows the main flow path and the second air manifold to communicate with each other, and a flow path width of each of the first sub flow path and the second sub flow path is narrower than a flow path width of the main flow path.

[6] The slot-type spray nozzle according to [5] in which the flow path width of each of the first sub flow path and the second sub flow path is 1 mm or less.

[7] The slot-type spray nozzle according to any one of [1] to [6] in which a flow path that allows the coating fluid manifold and the plurality of coating fluid discharge ports to communicate with each other is branched in the width direction at a position closer to the coating fluid discharge surface than a fastening position of the fixing bolt such that the number of branched flow paths increases from the coating fluid manifold toward the plurality of coating fluid discharge ports.

[8] The slot-type spray nozzle according to any one of [2] to [7] in which a flow path that allows the coating fluid manifold and the plurality of coating fluid discharge ports to communicate with each other is branched in the width direction such that the number of branched flow paths increases from the coating fluid manifold toward the plurality of coating fluid discharge ports, and the flow path branching in the width direction is disposed at a position overlapping with the second air manifold as viewed from the layer direction.

The slot-type spray nozzle of the present invention is small, lightweight, and excellent in handling property, and can form a thin and wide uniform coating film on a wide substrate.

### BRIEF DESCRIPTION OF THE DRAWINGS

FIG. 1 is a perspective view illustrating a schematic configuration and a coating state of a slot-type spray nozzle of the present invention.

FIG. 2 is a view facing a cross-sectional hatched portion in FIG. 1.

FIG. 3 is a coating fluid discharge surface view of the slot-type spray nozzle of the present invention as viewed from a coating fluid discharge port side.

FIG. 4 is a plan view of a coating fluid shim plate as viewed from a cross-sectional line A-A in FIG. 3.

FIG. 5 is an exploded perspective view for explaining a structure of the slot-type spray nozzle of FIG. 1.

FIG. 6 is a cross-sectional view for explaining a preferred embodiment of the slot-type spray nozzle of the present invention, and is a view as viewed from a cross-sectional line C-C in FIG. 7.

FIG. 7 is a plan view of an air shim plate as viewed from a cross-sectional line B-B in FIG. 6.

FIG. 8 is an exploded perspective view for explaining the structure of the spray nozzle of FIGS. 6 and 7.

FIG. 9 is a cross-sectional view for explaining a more preferred aspect of the slot-type spray nozzle of the present invention, and is a view as viewed from a cross-sectional line E-E in FIG. 10.

FIG. 10 is a plan view of a coating fluid shim plate as viewed from a cross-sectional line D-D in FIG. 9.

FIG. 11 is an exploded perspective view for explaining the structure of the spray nozzle of FIGS. 9 and 10.

FIG. 12 is a cross-sectional view of the spray nozzle for explaining an arrangement position of the fixing bolt of the slot-type spray nozzle of the present invention.

FIG. 13 is a cross-sectional view for explaining another preferred aspect of the spray nozzle illustrated in FIGS. 6 and 7.

### DETAILED DESCRIPTION OF EMBODIMENTS OF THE INVENTION

As a result of intensive studies on the above problems, the present inventors have found a nozzle structure in which fixing bolts for fastening a pair of nozzle blocks are arranged in the vicinity of the coating fluid discharge ports, and have reached the present invention. The nozzle block is pressed by the fastening force of the fixing bolt so that the nozzle block and the shim plate layer are in close contact with each other, and a compressive force is applied to the shim plate layer in the vicinity of the coating fluid discharge port and the air discharge port at the nozzle tip portion, whereby the deformation of the shim plate due to the nozzle internal pressure can be suppressed. Further, when the nozzle is widened in order to increase the coating width or the nozzle is downsized in order to reduce the weight, even if the tightness between the nozzle block and the shim plate layer is deteriorated due to a decrease in processing accuracy of the nozzle block, the nozzle block can be deformed by the fastening force to improve the tightness.

As a result, the flow path shape of the coating fluid discharge port, the air discharge port, and the like can be maintained with high accuracy, and high spray uniformity of the coating fluid can be obtained in the width direction.

The gas constituent component of the pressurized air used in the present invention is not limited, and nitrogen gas or the like can also be used. The coating fluid used for spray coating is not particularly limited, and examples thereof include solutions of inorganic substances and organic substances, and slurries in which inorganic substances and organic substances are dispersed in a binder and a solvent. The viscosity of the coating fluid is required to be low enough to miniaturize the coating fluid by the discharged air, and is generally preferably 500 mPas or less.

Hereinafter, embodiments of the present invention will be described in detail with reference to the drawings. The following description is given to facilitate understanding of the present invention, and does not limit the present invention at all. The scope of rights of the present invention is not limited to the following embodiments, and includes all modifications within the scope equivalent to the configurations described in the claims.

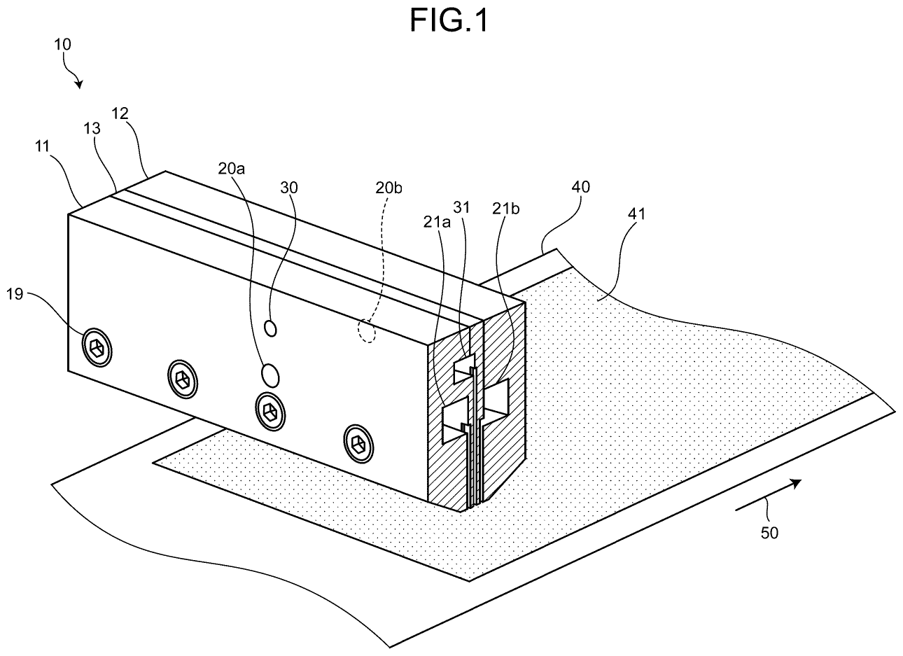

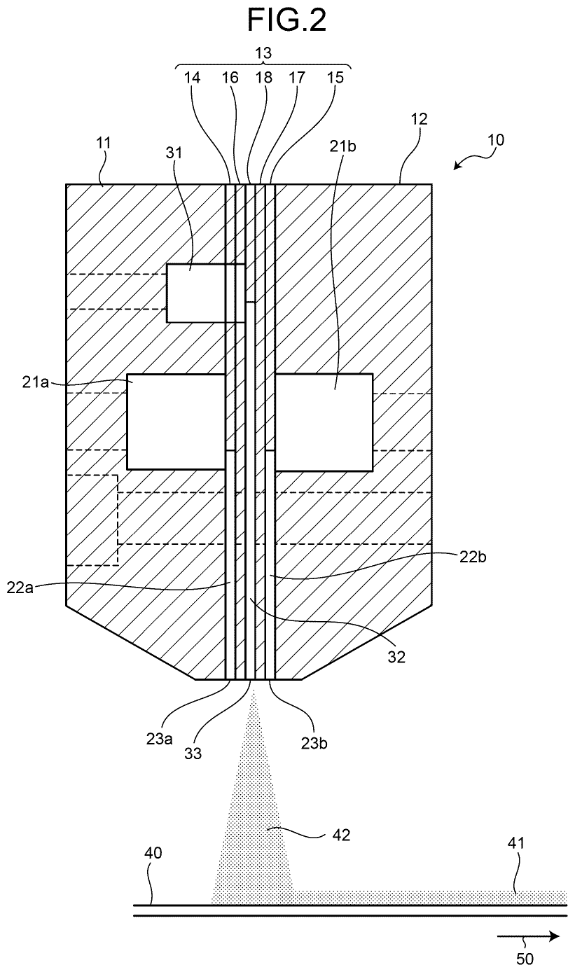

FIG. 1 is a perspective view illustrating a schematic configuration and a coating state of a slot-type spray nozzle of the present invention, and FIG. 2 is a view facing a cross-sectional hatched portion in FIG. 1.

A slot-type spray nozzle 10 has a longitudinal direction in a direction orthogonal to a conveyance direction 50 of a long substrate 40, that is, a width direction of the substrate 40, and is disposed so as to face the coating surface of the substrate 40 with a certain distance from the substrate 40.

The slot-type spray nozzle 10 includes a pair of nozzle blocks 11 and 12 and a shim plate layer 13 disposed therebetween, and these are fastened by a plurality of fixing bolts 19 arranged in the width direction. As illustrated in FIG. 2, in the shim plate layer 13, a first air shim plate 14, a first partition shim plate 16, a coating fluid shim plate 18, a second partition shim plate 17, and a second air shim plate 15 are layered in this order.

The coating fluid is supplied from a coating fluid supply system (not illustrated) to a coating fluid supply port 30 illustrated in FIG. 1 and provided in the spray nozzle 10 at the center in the width direction, and is uniformly widened in the width direction via a coating fluid manifold 31 extending in the width direction. Further, the discharged air is supplied from a pressure air source (not illustrated) to air supply ports 20a and 20b provided in the front surface and the back surface of the spray nozzle 10 at the center in the width direction, respectively, and is uniformly widened in the width direction via air manifolds 21a and 21b extending in the width direction.

The coating fluid widened in the width direction by the coating fluid manifold 31 passes through a coating fluid connection flow path 32 formed by the first partition shim plate 16, the second partition shim plate 17, and the coating fluid shim plate 18 illustrated in FIG. 2, and is discharged from a coating fluid discharge port 33.

The pressurized air widened in the width direction by the air manifold 21a passes through an air connection flow path 22a formed by the nozzle block 11, the first air shim plate 14, and the first partition shim plate 16, and is discharged from a first air discharge port 23a. Similarly, the pressurized air widened in the width direction by the air manifold 21b passes through an air connection flow path 22b formed by the nozzle block 12, the second air shim plate 15, and the second partition shim plate 17, and is discharged from a second air discharge port 23b.

The coating fluid discharged from a coating fluid discharge port 33 is sandwiched between the high-speed air discharged from the first air discharge port 23a and the high-speed air discharged from the second air discharge port 23b, becomes a fine droplet group 42, flies in an air discharge direction, and adheres onto a conveyed substrate 40, thereby forming a coating film 41.

The material of the member constituting the slot-type spray nozzle is not particularly limited, and a metal material, particularly a stainless material can be used from the viewpoint of processing accuracy and durability. In addition, since the slot-type spray nozzle 10 of the present invention has a structure that is not easily affected by the shape accuracy of the nozzle blocks 11 and 12, a non-metallic material such as a resin block that is not easily processed accurately can be suitably used for the nozzle block.

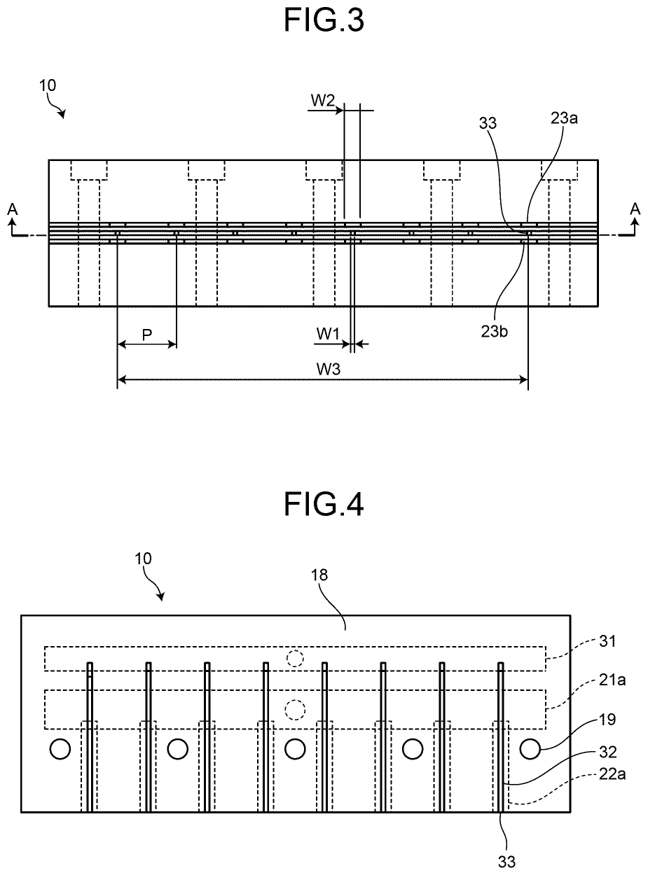

FIG. 3 is a coating fluid discharge surface view of the slot-type spray nozzle of the present invention as viewed from a coating fluid discharge port side, and FIG. 4 is a coating fluid shim plate plan view as viewed from a cross-sectional line A-A of FIG. 3.

At the coating fluid discharge surface of the slot-type spray nozzle 10 illustrated in FIG. 3, that is, at the nozzle tip portion, the coating fluid discharge port 33 has a rectangular opening end having a width W1, and a plurality of the coating fluid discharge ports 33 are arranged at equal pitches in the width direction so as to have a spray width W3 as a whole. In the vicinity of the coating fluid discharge port 33, a pair of the first air discharge port 23a and the second air discharge port 23b having a slit shape with a width W2 are arranged in the width direction at the same pitch as the coating fluid discharge port 33 so as to sandwich the coating fluid discharge port 33.

In the coating fluid discharge surface of the slot-type spray nozzle 10, there is a region where the coating fluid discharge port 33 and the air discharge ports 23a and 23b do not exist in the width direction of the slot-type spray nozzle 10. That is, since there is a region where the coating fluid discharge port 33 and the air discharge ports 23a and 23b do not exist in the vicinity of the coating fluid discharge surface, the fixing bolt 19 can be penetrated in the layer direction of the spray nozzle 10 in the vicinity of the coating fluid discharge surface to fasten the nozzle blocks 11a and 11b and the shim plate layer 13, and the fixing bolt fastening force can be transmitted from the nozzle blocks 11 and 12 to the coating fluid shim plate 18 even in the vicinity of the coating fluid discharge surface.

An optimum value of the width W1 of each of the coating fluid discharge ports 33 varies depending on the viscosity of the coating fluid to be used and the flow rate of the coating fluid to be discharged, but the width W1 is preferably 100 μm or more from the viewpoint of reducing processing variation of the shape of each of the coating fluid discharge ports. In addition, the width is preferably 400 μm or less in order to apply an appropriate internal pressure into the coating fluid manifold 31 and uniformly distribute the coating fluid to each of the coating fluid discharge ports 33. The thickness of the coating fluid discharge port 33, that is, the thickness of the coating fluid shim plate 18 is preferably 200 μm or less for the same reason. The arrangement pitch P of the coating fluid discharge ports 33 is preferably as narrow as possible from the viewpoint of uniformity in the width direction of the coating film, and specifically, is preferably 20 mm or less. The width W2 of the first air discharge port 23a and the second air discharge port 23b is preferably longer than the width W1 of the coating fluid discharge port 33 in order to stably miniaturize the coating fluid discharged from the coating fluid discharge port 33 by the discharged air, but is preferably 3 mm or less in order to sufficiently apply the fastening force of the fixing bolt 19 to the vicinity of the coating fluid discharge port 33.

The thickness of each of the first air discharge port 23a and the second air discharge port 23b, that is, the thickness of each of the first air shim plate 14 and the second air shim plate 15 is preferably 100 μm or less, more preferably 50 μm or less, from the viewpoint of increasing the speed of the discharged air in order to miniaturize the coating fluid. In addition, as the first air discharge port 23a and the second air discharge port 23b are closer to the coating fluid discharge port 33, the discharged air can be applied to the coating fluid at a higher speed. Therefore, the thickness of each of the first partition shim plate 16 and the second partition shim plate 17 is preferably 100 μm or less, more preferably 50 μm or less.

As illustrated in FIG. 4, a plurality of fixing bolts 19 are disposed at positions not overlapping with the coating fluid connection flow path 32 and the air connection flow path 22a and at positions closer to the coating fluid discharge port 33 than the coating fluid manifold 31 and the air manifolds 21a and 21b when viewed from the layer direction of the slot-type spray nozzles 10. By arranging the fixing bolts 19 in the vicinity of the coating fluid discharge port 33, the fastening force of the fixing bolts 19 is applied to the coating fluid connection flow path 32, the coating fluid discharge port 33, the air connection flow paths 22a and 22b, the first air discharge port 23a, and the second air discharge port 23b, and the flow path shape and the discharge port shape can be maintained with high accuracy. Although depending on the width of the slot-type spray nozzle 10, it is preferable to provide at least one fixing bolt 19 between the coating fluid connection flow paths 32 in addition to the two fixing bolts 19 present at both ends in the width direction of the slot-type spray nozzle 10.

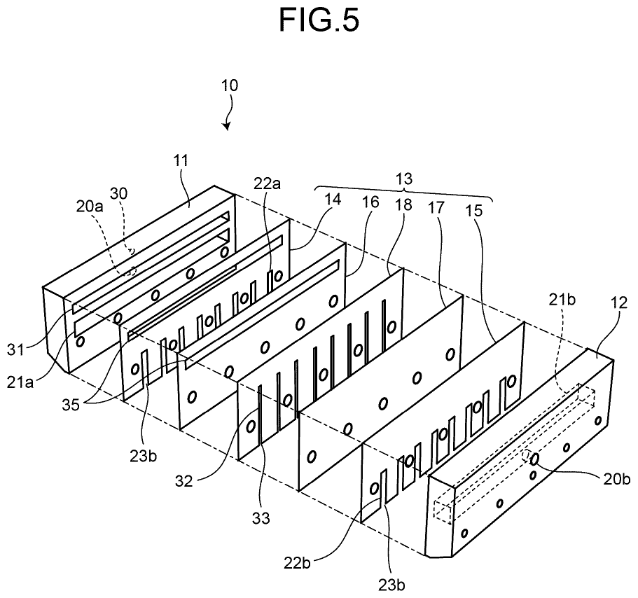

FIG. 5 is an exploded perspective view for explaining a structure of the slot-type spray nozzle of FIG. 1. In the nozzle block 11, a coating fluid supply port 30 for receiving the coating fluid and a coating fluid manifold 31 for widening the coating fluid in the width direction are formed, and the coating fluid supply port 30 communicates with the coating fluid manifold 31. In the nozzle block 11, an air supply port 20a for receiving air and an air manifold 21a for widening the air in the width direction are formed, and the air supply port 20a communicates with the air manifold 21a. Similarly, in the nozzle block 12, an air supply port 20b for receiving air and an air manifold 21b for widening the air in the width direction are formed, and the air supply port 20b communicates with the air manifold 21b.

The first air shim plate 14 has a comb teeth shape, and when the first air shim plate 14 is layered with the nozzle block 11 and the first partition shim plate 16, a plurality of air connection flow paths 22a and first air discharge ports 23a are formed in the width direction by grooves between comb teeth of the first air shim plate 14. The groove between the comb teeth of the first air shim plate 14 is formed at a position communicating with the air manifold 21a, and can guide the pressurized air supplied to the air supply port 20a to the first air discharge port 23a. Similarly, the second air shim plate 15 also has a comb teeth shape, and when the second air shim plate 15 is layered with the nozzle block 12 and the second partition shim plate 17, a plurality of air connection flow paths 22b and second air discharge ports 23b are formed in the width direction by the grooves between the comb teeth of the second air shim plate 15. The groove between the comb teeth of the second air shim plate 15 is formed at a position communicating with the air manifold 21b, and can guide the pressurized air supplied to the air supply port 20b to the second air discharge port 23b.

The coating fluid shim plate 18 has a comb tooth shape similarly to the first air shim plate 14 and the second air shim plate 15, and when the coating fluid shim plate 18 is layered with the first partition shim plate 16 and the second partition shim plate 17, a plurality of coating fluid connection flow paths 32 and coating fluid discharge ports 33 are formed in the width direction by grooves between comb teeth of the coating fluid shim plate 18. The coating fluid connection flow path 32 communicates with the coating fluid manifold 31 through the first air shim plate 14 and a cutout portion 35 of the first partition shim plate 16, and can guide the supplied coating fluid to the coating fluid discharge port 33.

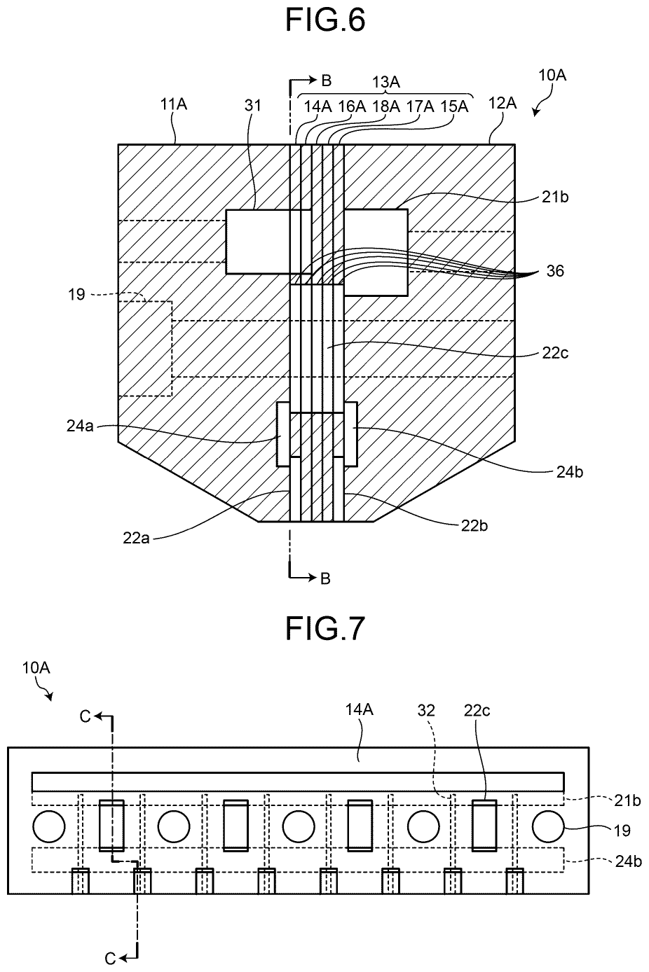

FIG. 6 is a cross-sectional view for explaining another aspect of the slot-type spray nozzle of the present invention, and is a view as viewed from a cross-sectional line C-C in FIG. 7. FIG. 7 is a plan view of the air shim plate taken along the cross-sectional line B-B in FIG. 6.

Unlike the slot-type spray nozzle 10 of the aspect of FIG. 5, in the slot-type spray nozzle 10A of the present aspect, the air manifold 21a is not formed in the nozzle block 11A, and the air manifold 21b is formed only in the nozzle block 12A in which the coating fluid manifold 31 is not formed, and the coating fluid manifold 31 and the air manifold 21b are arranged to overlap with each other when viewed from the layer direction of the spray nozzle 10A.

The spray nozzle 10A of the aspect of FIG. 6 further includes a second air manifold at a position closer to the nozzle tip portion than the fixing bolt 19. By providing the second air manifold 24a in the nozzle block 11A and the second air manifold 24b in the nozzle block 12A, the air supplied to the slot-type spray nozzle 10A can be further widened in the width direction not only by the air manifold 21b but also by the second air manifolds 24a and 24b, so that the uniformity in the width direction of the discharged air can be further enhanced.

In the first air shim plate 14A, the second air shim plate 15A, the first partition shim plate 16A, the second partition shim plate 17A, and the coating fluid shim plate 18A, cutouts 36 for forming air connection flow paths 22c are provided in the same shape, and the air connection flow paths 22c communicate with each other in the layer direction of the shim plate layer 13A. The second air manifold 24a is provided so as to bridge the air connection flow path 22c and the air connection flow path 22a, and the second air manifold 24b is provided so as to bridge the air connection flow path 22c and the air connection flow path 22b. The second air manifold may be provided only in the nozzle block on one side. For example, the second air manifold 24a may be provided only on the side of the nozzle block 11A, and an air connection flow path that further communicates the air manifold 24a and the air connection flow path 22b may be provided.

As illustrated in FIG. 7, the air connection flow path 22c connecting the second air manifold 24b and the air manifold 21b is preferably formed at a position not overlapping with the coating fluid connection flow path 32 when viewed from the layer direction of the spray nozzles 10A. As a result, as illustrated in FIG. 6, the air connection flow path 22c can be formed such that the shim plate layer 13A communicates in the layer direction to increase the flow path thickness. Since the flow path resistance can be reduced by increasing the flow path thickness, the air pressure inside the nozzle can be reduced when compared at the same air discharge amount, and deformation of the shim plate layer 13A can be further reduced. In addition, since the air supply pressure can be reduced, the load on the air supply system can be reduced.

As illustrated in FIG. 6, it is preferable that the air manifold is formed only in the nozzle block 12A in which the coating fluid manifold 31 is not formed, and is arranged so as to overlap with the coating fluid manifold 31 when viewed from the layer direction of the spray nozzle 10A. As a result, the overall height of the spray nozzle 10A can be reduced, so that the spray nozzle 10A can be downsized and the handling property can be further improved. In addition, the air supply system can be simplified with only one air supply location.

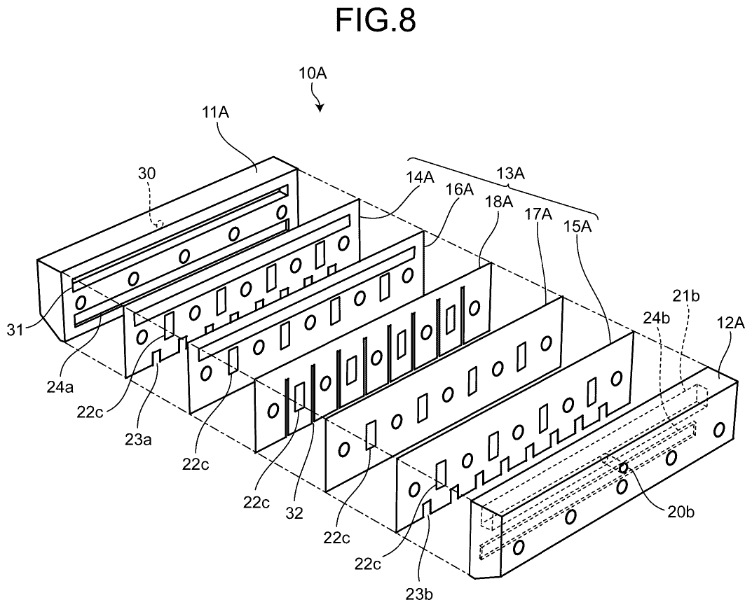

FIG. 8 is an exploded perspective view for explaining the structure of the slot-type spray nozzle 10A of FIGS. 6 and 7. In FIG. 8, the description of the same configuration as that of FIG. 5 is omitted. The first air shim plate 14A, the second air shim plate 15A, the first partition shim plate 16A, the second partition shim plate 17A, and the coating fluid shim plate 18A are provided with cutouts for forming the air connection flow paths 22c in the same shape, and the air connection flow paths 22c communicate with each other in the layer direction of the shim plate layer 13A. The pair of nozzle blocks 11A and 12A are provided with the second air manifolds 24a and 24b, respectively, and the air connection flow path 22c communicates with the air manifold 21b and the second air manifolds 24a and 24b, so that the air received from the air manifold 21b can be distributed to both of the second air manifolds 24a and 24b and further distributed to the first air discharge port 23a and the second air discharge port 23b.

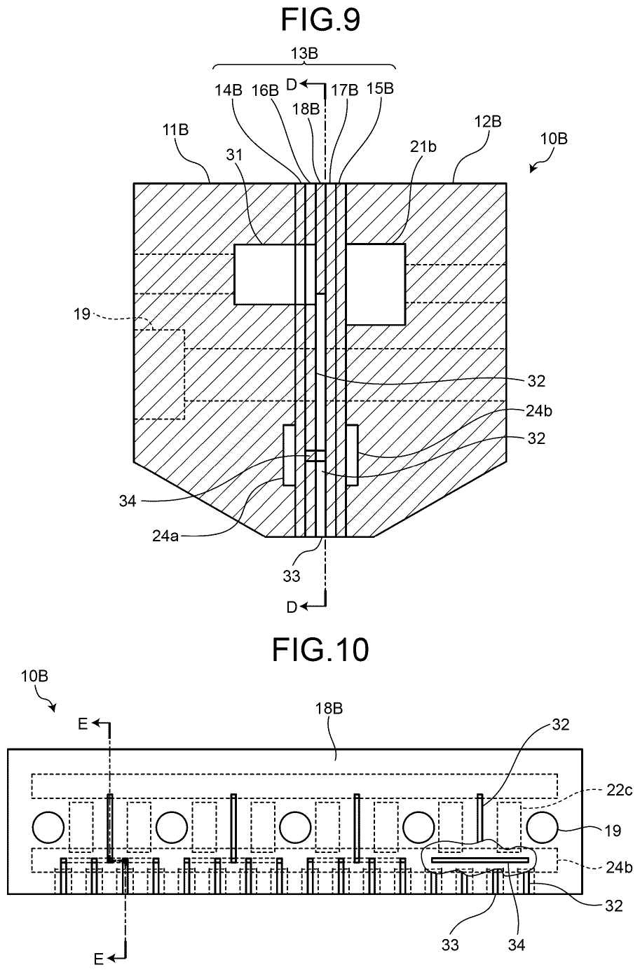

FIG. 9 is a cross-sectional view for explaining still another aspect of the slot-type spray nozzle of the present invention, and is a view viewed from a cross-sectional line E-E in FIG. 10. FIG. 10 is a plan view of the coating fluid shim plate taken along line D-D in FIG. 9.

In a slot-type spray nozzle 10B of the present aspect, similarly to the slot-type spray nozzle 10A of FIG. 6, the air manifold 21a is not formed in a nozzle block 11B, the air manifold 21b is formed only in the nozzle block 12B in which the coating fluid manifold 31 is not formed, and the coating fluid manifold 31 and the air manifold 21b are arranged to overlap with each other when viewed from the layer direction of the spray nozzles 10B. Further, the slot-type spray nozzle 10B includes a second air manifold 24a in the nozzle block 11B and a second air manifold 24b in the nozzle block 12B.

As illustrated in FIG. 10, in the slot-type spray nozzle 10B, the coating fluid connection flow path 32 is branched by a coating fluid branch flow path 34 at a position closer to the coating fluid discharge surface than the position where the fixing bolts 19 are arranged when viewed from the layer direction of the spray nozzle 10B, and is connected to the plurality of coating fluid discharge ports 33.

In a case where the coating fluid discharge ports 33 are greatly increased for the purpose of equalizing the spray amount of the coating fluid in the width direction, even if the coating fluid manifold 31 to the plurality of coating fluid discharge ports 33 are directly connected by the coating fluid connection flow path 32, they interfere with the fixing bolt 19. In the present embodiment, by branching the coating fluid connection flow path 32 in the width direction beyond the position where the fixing bolts 19 are arranged, the coating fluid connection flow path can be connected to the plurality of coating fluid discharge ports 33 without being affected by the arrangement of the fixing bolts 19. As a result, since the number of the coating fluid discharge ports 33 can be increased, the arrangement pitch of the coating fluid discharge ports 33 can be reduced, and the spray uniformity in the width direction can be improved. In this case, the coating fluid branch flow path 34 is formed in the first partition shim plate 16B as illustrated in FIG. 9, but may be formed in the second partition shim plate 17B or may be formed in both of them. Alternatively, two or more coating fluid shim plates 18B may be layered, and the coating fluid branch flow path 34 may be formed on one or more of them.

In the present embodiment, as illustrated in FIG. 10, the coating fluid branch flow path 34 is disposed at a position overlapping with the second air manifolds 24a, 24b. As a result, the slot-type spray nozzle 10B can be downsized.

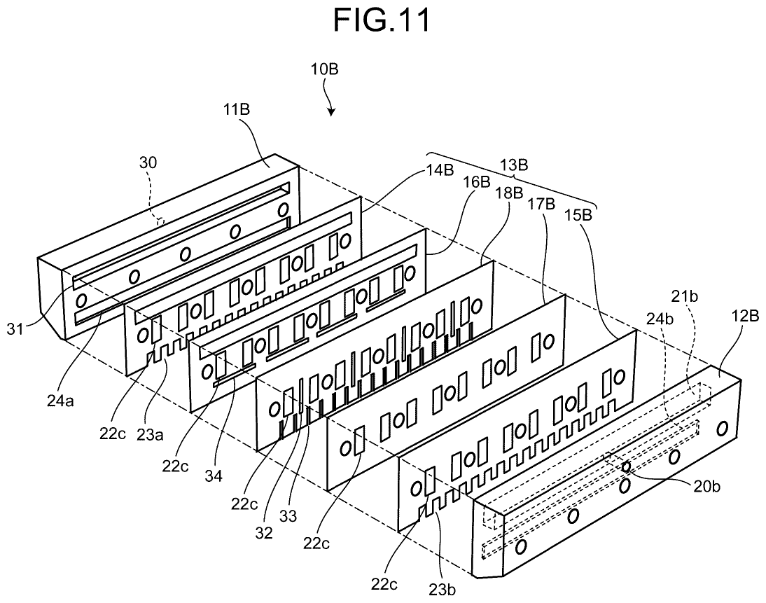

FIG. 11 is an exploded perspective view for explaining the structure of the slot-type spray nozzle 10B of FIGS. 9 and 10. In FIG. 11, the description of the same configuration as that of FIG. 5 is omitted. In the first air shim plate 14B, the second air shim plate 15B, the first partition shim plate 16B, the second partition shim plate 17B, and the coating fluid shim plate 18B, similarly to the slot-type spray nozzle 10A, cutouts for forming the air connection flow paths 22c are provided in the same shape, and the air connection flow paths 22c communicate with each other in the layer direction of the shim plate layer 13B. The first partition shim plate 16B is provided with a cutout for forming the coating fluid branch flow path 34, and the coating fluid supplied from the coating fluid connection flow path 32 can be distributed to the plurality of coating fluid discharge ports 33. The pair of nozzle blocks 11B and 12B are provided with the second air manifolds 24a and 24b, respectively, and the air connection flow path 22c communicates with the air manifold 21b and the second air manifolds 24a and 24b, so that the air received from the air manifold 21b can be distributed to both of the second air manifolds 24a and 24b and further distributed to the first air discharge port 23a and the second air discharge port 23b. In the shim plate layer 13B, in order to change the flow path shape in the shim layer direction, a plurality of coating fluid shim plates 18B, a plurality of first air shim plates 14B, and a plurality of second air shim plates 15B may be provided, and a total of six or more shim plates may be layered.

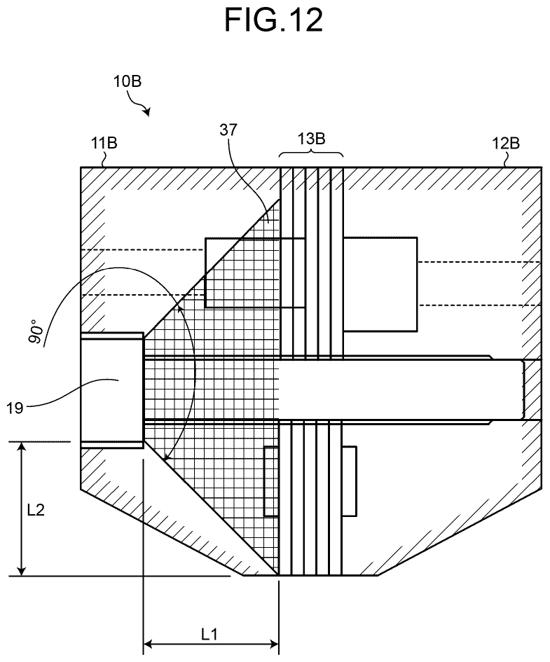

Next, FIG. 12 is a cross-sectional view for explaining arrangement positions of fixing bolts of the slot-type spray nozzle of the present invention. The grid-like hatching in FIG. 12 schematically indicates a fastening force action range 37 of the fixing bolt 19. The fastening force action range 37 is a portion where a truncated cone-shaped virtual body having an apex angle of 90° and the nozzle block 11B overlap with each other with the bearing surface (contact portion between the head portion of the fixing bolt 19 and the nozzle block 11B) of the fixing bolt 19 as an upper bottom surface, and in this range, the nozzle block 11B can effectively act the fastening force on the shim plate layer 13B. Therefore, assuming that the distance from the bearing surface of the fixing bolt 19 to the shim plate layer 13B is L1 and the distance from the bolt bearing surface to the nozzle tip portion is L2, in order to apply a fixing fastening force to the nozzle tip portion of the shim plate layer 13B, it is preferable to arrange the fixing bolt 19 so as to satisfy L2<L1.

In the conventional shim plate layer-type nozzle, since the two nozzle blocks and the shim plate are fastened at a position away from the nozzle tip portion, a fixing fastening force hardly acts on the nozzle tip portion. That is, a force that presses each of the two nozzle blocks against the shim plate is less likely to act at the nozzle tip portion. Therefore, if the flatness of the surface in contact with the shim plate of each of the two nozzle blocks is not increased, the nozzle block and the shim do not come into close contact with each other. Furthermore, in general, when the coating width of the nozzle increases, the influence of warpage, self-weight deformation, and the like increases, and the processing accuracy becomes difficult to be obtained. Therefore, in order to maintain the flatness of the nozzle block at a high level, it is necessary to increase the width of the nozzle block in the layer direction to increase the rigidity. Therefore, the nozzle block becomes large, and as a result, handling of the entire nozzle is deteriorated.

On the other hand, in the slot-type spray nozzle 10B of the present invention, since the two nozzle blocks 11B and 12B and the shim plate layer 13B are fastened at a position close to the nozzle tip portion, a fixing fastening force acts up to the nozzle tip portion. That is, also at the nozzle tip portion, a force that presses each of the two nozzle blocks 11B and 12B toward the shim plate layer 13B acts. Therefore, even if the nozzle block 11B (12B) does not have high rigidity and flatness, the nozzle block 11B (12B) is deformed along the shim plate layer 13B, so that the nozzle block 11B (12B) and the shim plate layer 13B are brought into close contact with each other. Furthermore, since it is not necessary to increase the rigidity of the nozzle block 11B (12B), even if a coating width W3 illustrated in FIG. 3 is increased, it is not necessary to increase the width of the nozzle block 11B (12B) in the layer direction, and handling of the entire spray nozzle 10B is good. It is preferable that L1 is 1/10 times or less the coating width W3 from the viewpoint of the handling property of the spray nozzle 10B. In the above description, the slot-type spray nozzle 10B has been described as an example of the fastening force action range 37 of the fixing bolt 19, but the same applies to the slot-type spray nozzles 10 and 10A which are other aspects of the present invention.

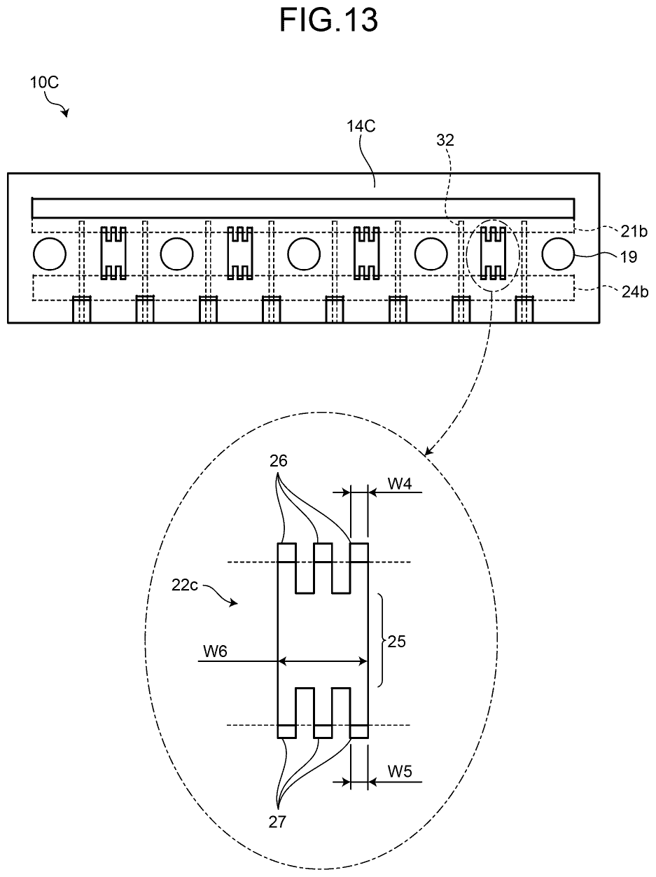

FIG. 13 is a cross-sectional view for explaining another preferred aspect of the slot-type spray nozzle illustrated in FIGS. 6 and 7.

In the slot-type spray nozzle 10C of the present aspect, similarly to the slot-type spray nozzle 10A of FIG. 6, the air manifold 21a is not formed in the nozzle block 11a, the air manifold 21b is formed only in the nozzle block 11C (not illustrated) in which the coating fluid manifold 31 is not formed, and the coating fluid manifold 31 and the air manifold 21b are arranged to overlap with each other when viewed from the layer direction of the spray nozzle 10C. Further, the slot-type spray nozzle 10C includes the second air manifold 24a in the nozzle block 11C and the second air manifold 24b in the nozzle block 12C (not illustrated).

The air connection flow path 22c of the slot-type spray nozzle 10C illustrated in FIG. 13 includes a main flow path 25, a first sub flow path 26, and a second sub flow path 27, the first sub flow path 26 is formed at a position where the air manifold 21b communicates with the main flow path 25, and the second sub flow path 27 is formed at a position where the main flow path 25 communicates with the second air manifold 24b. Each of the width W4 of the first sub flow path 26 and the width W5 of the second sub flow path is narrower than the width W6 of the main flow path 25, and the first sub flow paths and the second sub flow paths are formed in plurality. As described above, the air manifold 21b and the second air manifold 24b communicate with each other via the air connection flow path 22c including the first sub flow path 26 and the second sub flow path 27 having a narrow width provided in a part of the air connection flow path 22c, so that it is possible to reduce the flow velocity component in the width direction of the air flowing in the air manifold 21b and supply the air to the second air manifold 24b while suppressing an increase in flow path resistance. This makes it possible to reduce air discharge variation for each of the first and second air discharge ports.

As illustrated in FIG. 12, it is preferable to form a plurality of first sub flow paths 26 and a plurality of second sub flow paths 27 in one air connection flow path 22c because the flow path resistance can be further reduced. In addition, each of the width W4 of the first sub flow path 26 and the width W5 of the second sub flow path is preferably 1 mm or less from the viewpoint of sufficiently reducing the flow velocity component in the width direction of the air.

### REFERENCE SIGNS LIST

10, 10A, 10B, 10C SPRAY NOZZLE
11, 11A, 11B, 12, 12A, 12B NOZZLE BLOCK
13, 13A, 13B SHIM PLATE LAYER
14, 14A, 14B FIRST AIR SHIM PLATE
15, 15A, 15B SECOND AIR SHIM PLATE
16, 16A, 16B FIRST PARTITION SHIM PLATE
17, 17A, 17B SECOND PARTITION SHIM PLATE
18, 18A, 18B COATING FLUID SHIM PLATE
19 FIXING BOLT
20a, 20b AIR SUPPLY PORT
21a, 21b AIR MANIFOLD
22a, 22b, 22c AIR CONNECTION FLOW PATH
23a FIRST AIR DISCHARGE PORT
23b SECOND AIR DISCHARGE PORT
24a, 24b SECOND AIR MANIFOLD
25 MAIN FLOW PATH
26 FIRST SUB FLOW PATH
27 SECOND SUB FLOW PATH
30 COATING FLUID SUPPLY PORT
31 COATING FLUID MANIFOLD
32 COATING FLUID CONNECTION FLOW PATH
33 COATING FLUID DISCHARGE PORT
34 COATING FLUID BRANCH FLOW PATH
35, 36 CUTOUT PORTION
37 FASTENING FORCE ACTING RANGE
40 SUBSTRATE
41 COATING FILM
42 DROPLET GROUP
50 CONVEYANCE DIRECTION
L1 DISTANCE FROM FIXING BOLT BEARING SURFACE TO SHIM PLATE LAYER
L2 DISTANCE FROM BOLT BEARING SURFACE TO NOZZLE TIP PORTION
P ARRANGEMENT PITCH OF COATING FLUID DISCHARGE PORTS
W1 COATING FLUID DISCHARGE WIDTH
W2 AIR DISCHARGE WIDTH
W3 SPRAY WIDTH
W4 WIDTH OF FIRST SUB FLOW PATH
W5 WIDTH OF SECOND SUB FLOW PATH
W6 WIDTH OF MAIN FLOW PATH

1. A slot-type spray nozzle comprising at least two nozzle blocks, two air shim plates, two partition shim plates, and one coating fluid shim plate, which are layered in this order from an outside and an entirety of which are fastened in a layer direction by fixing bolts, wherein
a surface from which coating fluid is discharged is defined as a coating fluid discharge surface, and a direction perpendicular to a direction in which the coating fluid is discharged and the layer direction is defined as a width direction,
a coating fluid manifold extending in the width direction and an air manifold extending in the width direction are provided,
in an end portion of the coating fluid shim plate on a side of the coating fluid discharge surface, grooves serving as a plurality of coating fluid discharge ports are formed at pitches, and the coating fluid manifold and the plurality of coating fluid discharge ports communicate with each other,
in an end portion of each of the two air shim plates on the side of the coating fluid discharge surface, grooves serving as a plurality of air discharge ports are formed at a pitch, and the air manifold and the plurality of air discharge ports communicate with each other,
the coating fluid discharge surface has a region where the coating fluid discharge ports and the air discharge ports do not exist in the layer direction, and
the fixing bolt fastens the slot-type spray nozzle at a position closer to the coating fluid discharge surface than the coating fluid manifold and the air manifold.

2. The slot-type spray nozzle according to claim 1, further comprising a second air manifold extending in the width direction at a position closer to the coating fluid discharge surface than a fastening position of the fixing bolt, wherein
the air manifold and the plurality of air discharge ports communicate with each other via the second air manifold.

3. The slot-type spray nozzle according to claim 2, wherein a flow path that allows the coating fluid manifold and the plurality of coating fluid discharge ports to communicate with each other is disposed at a position not overlapping with a flow path that allows the air manifold and the second air manifold to communicate with each other as viewed from the layer direction.

4. The slot-type spray nozzle according to claim 1, wherein
a recess constituting the coating fluid manifold is formed only in one of the nozzle blocks, and a recess constituting the air manifold is formed only in another of the nozzle blocks, and
the coating fluid manifold is disposed at a position overlapping with the air manifold as viewed from the layer direction.

5. The slot-type spray nozzle according to claim 4, wherein
a flow path that allows the air manifold and the second air manifold to communicate with each other includes a main flow path, a first sub flow path that allows the main flow path and the air manifold to communicate with each other, and a second sub flow path that allows the main flow path and the second air manifold to communicate with each other, and
a flow path width of each of the first sub flow path and the second sub flow path is narrower than a flow path width of the main flow path.

6. The slot-type spray nozzle according to claim 5, wherein the flow path width of each of the first sub flow path and the second sub flow path is 1 mm or less.

7. The slot-type spray nozzle according to claim 1, wherein a flow path that allows the coating fluid manifold and the plurality of coating fluid discharge ports to communicate with each other is branched in the width direction at a position closer to the coating fluid discharge surface than a fastening position of the fixing bolt such that the number of branched flow paths increases from the coating fluid manifold toward the plurality of coating fluid discharge ports.

8. The slot-type spray nozzle according to claim 2, wherein
a flow path that allows the coating fluid manifold and the plurality of coating fluid discharge ports to communicate with each other is branched in the width direction such that the number of branched flow paths increases from the coating fluid manifold toward the plurality of coating fluid discharge ports, and
the flow path branching in the width direction is disposed at a position overlapping with the second air manifold as viewed from the layer direction.
